(19) United States
(12) Patent Application Publication
(10) Pub. No.: US 2026/0332719 A1
(43) Pub. Date: Oct. 22, 2026

(54) COLOR TABLE ALTERATIONS

(71) Applicant: Hewlett-Packard Development Company, L.P., Spring, TX (US)

(72) Inventors: Namju SHIN, Seongnam Si (KR); Hyunsoo OH, Seongnam Si (KR); Woojun CHUNG, Seongnam Si (KR); Hyojoong KIM, Seongnam Si (KR); Mark Q. SHAW, Boise, ID (US); Di-Yuan TZENG, Boise, ID (US)

(21) Appl. No.: 19/110,552

(22) PCT Filed: Sep. 12, 2022
(86) PCT No.: PCT/US2022/043195

§ 371 Date: Mar. 11, 2025

(51) Int. Cl. H04N 1/60; H04N 1/00; H04N 1/62

(52) U.S. Cl. CPC H04N 1/6055; H04N 1/00411; H04N 1/62

(57) ABSTRACT

The present disclosure describes a device that includes instructions to align a first scanned image of a printout of a first test image with a second scanned image of a printout of a second test image such that colors from the first test image are aligned with corresponding colors from the second test image, determine a difference between the colors from the first scanned image and the corresponding colors from the second scanned image, identify color values for the colors from the first test image based on an identifier of a first printing device that generated the printout of the first test image, and alter the corresponding colors of a color table of a second printing device that generated the printout of the second test image based on the difference and the color values for the colors from the first test image.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry or otherwise bring the computing device along while in a mobile setting. These computing devices can utilize printing devices to generate images on a substrate or print medium. The printing device can perform a plurality of different printing functions to increase an image quality of the images generated on the print medium. The printing device can utilize a plurality of different print substances such as ink, toner, or other types of print substances.

### BRIEF DESCRIPTION OF THE DRAWINGS

FIG. 1 illustrates an example of a system for performing color table alterations.

FIG. 2 illustrates an example of a user interface for performing color table alterations.

FIG. 3 illustrates an example of a user interface for performing color table alterations.

FIG. 4 illustrates an example of a device for performing color table alterations.

FIG. 5 illustrates an example of a memory resource storing instructions for performing color table alterations.

FIG. 6 illustrates an example of a method for performing color table alterations.

### DETAILED DESCRIPTION

A user may utilize a computing device for various purposes, such as for business and/or recreational use. As used herein, the term “computing device” refers to an electronic system having a processor (e.g., processor resource, hardware processor, etc.) and a memory resource. Examples of computing devices can include, for instance, a laptop computer, a notebook computer, a desktop computer, an all-in-one (AIO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are (or can be) carried and/or worn by a user.

Computing devices can be utilized with a plurality of peripheral devices and/or embedded devices. For example, computing devices can be included within or utilized with printing devices. As used herein, a printing device (e.g., printer, inkjet printer, laser printer, three-dimensional printer, etc.) can be a device that deposits a print substance on a substrate to generate an image on the substrate. For example, the printing device can be an inkjet printing device that deposits a printing fluid (e.g., ink, etc.) on to a sheet of print media (e.g., paper, plastic, etc.) to generate an image on the sheet of print media. In this example, the printing device can be communicatively coupled to a computing device that can provide print data for a print job to the printing device and/or be part of the printing device to receive print data from a remote computing device. As used herein, the print data for the print job can include information related to the image to be generated on the print media. For example, the print data can include a red-blue-green (RGB) input image to be generated on the substrate by the printing device.

Different printing devices can utilize different types of print substances that can be deposited in different quantities and combined to generate different colors. The different quantities, different combinations, and/or different color tables utilized to generate the image on a particular substrate can lead to different printing devices generating different looking images on the substrate even when utilizing the same print data to generate the image. For example, a particular image within print data can include the color green. In this example, a first printing device can receive the print data and generate the color green utilizing a first color table corresponding to the first printing device. The first color table can include color properties for the color green and corresponding printing parameters to define a quantity of print substance and/or combination of other colors to generate the color green. In this example, a second printing device can receive the same print data as the first printing device and utilize a second color table corresponding to the second printing device. In this way, the second printing device may utilize different print substances, different combinations of print substance colors, and/or different quantities of print substance based on the corresponding color tables, which can result in the color green for the image printed by the first printing device to appear different from the green for the image printed by the second printing device.

In some examples, a spectrophotometer can be utilized to compare the colors generate by a first printing device to colors generated by a second printing device. As used herein, a spectrophotometer is an instrument that measures the amount of photons (the intensity of light) absorbed after it passes through sample colorant. In these examples, the results of the color comparison can be utilized to alter a plurality of colors of a color table to mimic or resemble a different color table. For example, a color table can be shifted such that all of the colors within the color table are shifted or altered in the same or similar degree such that the altered color table will generate images that are similar to a different color table. However, utilizing a spectrophotometer can be a difficult device to identify differences between a first image and a second image and shift a color table based on the differences. In some cases shifting the color table of a first printing device to mimic a second printing device can result in a first plurality of colors printed by the first printing device to be similar to corresponding colors printed by the second printing device while a second plurality of colors printed by the first printing device are not similar to the corresponding colors printed by the second printing device.

The present disclosure describes performing color table alterations that more accurately alters a color table of a particular printing device to mimic a different printing device. In some examples, the color table alterations can be performed by an end user of a first printing device to mimic a second printing device. For example, the first printing device may be a printing device to be replaced and the second printing device can be the printing device to replace the first printing device. In this way, the color table alterations can ensure that the replacement printing device prints colors that are similar to the printing device being replaced. In specific examples, individual colors or regions of interests can be identified within a particular image to ensure that the individual colors or colors within the region of interest are more precisely similar between the replacement printing device and the printing device being replaced.

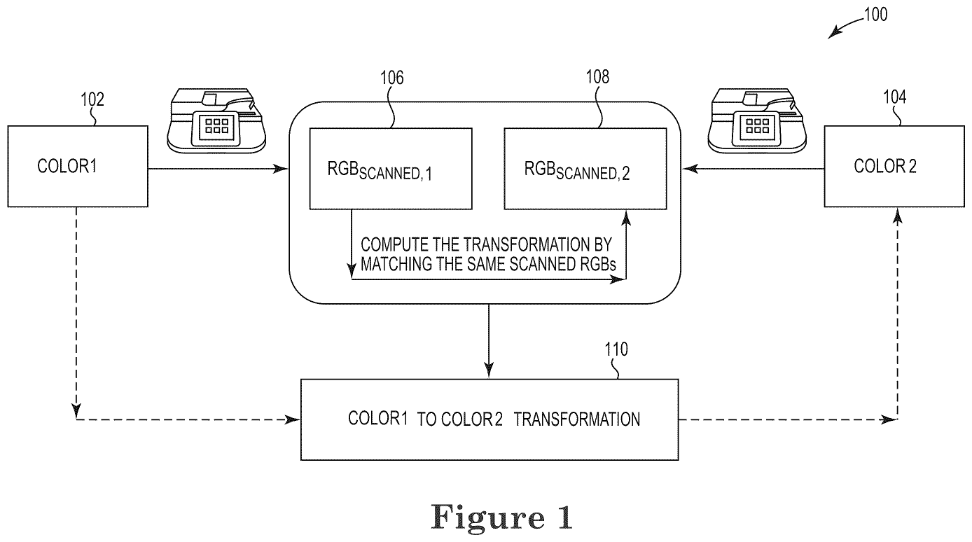

FIG. 1 illustrates an example of a system 100 for performing color table alterations. In some examples, the system 100 can illustrate how a first test image 102 that was printed by a first printing device can be compared to a second test image 104 printed by a second printing device to generate a transformation or emulation color table 110. As used herein, a color table can include an ordered collection of colors that is used to color a display according to a range of data values. In some examples, the color table can include a plurality of colors that a particular printing device is able to generate. In this way, a printing device can utilize the color table to generate an image based on print data received from a computing device.

In some examples, the first test image 102 can include an image that was printed by the first printing device on a substrate (e.g., print media, paper, plastic, etc.). In some examples, the image that was printed on a substrate to generate the first test image 102 can include a plurality of colors that correspond to a color table of the first printing device. For example, the first test image 102 can be a printout of a color table utilized by the first printing device. In some examples, the printout of the color table can be a plurality of color patches that are organized through a color gradient such that proximate color patches have more similar color properties compared to color patches that are further away.

As used herein, the color patches can represent a particular color that can be generated by a particular printing device that corresponds to a particular color of the color table utilized by the particular printing device. In this way, the first test image 102 can include a plurality of color patches that correspond to a plurality of colors of a first color table utilized by the first printing device. In a similar way, the second test image 104 can include a plurality of color patches that correspond to a plurality of colors of a second color table utilized by the second printing device.

In some examples, the first printing device can be provided with the same print data to print the first test image 102 as the second printing device is provided to print the second test image 104. For example, the print data utilized by the first printing device to print the first test image 102 can include the same color values as the print data utilized by the second printing device to print the second test image 104. In this way, the corresponding color patches of the first test image 102 can be compared to the corresponding color patches of the second test image 104. As described herein, even when the color values are the same, the print data can include features that are specific to a particular type of printing device. That is, the print data for the colors may be the same or similar while other portions of the print data may be different or specific to a particular type of printing device.

In some examples, a scanner device can be utilized to scan the first test image 102 to generate a first scanned test image 106 of the first test image 102 printed by the first printing device. In these examples, the scanner device can be utilized to scan the second test image 104 to generate a second scanned test image 108 printed by the second printing device. In some examples, the scanner device utilized to scan the first test image 102 can be the same scanner device utilized to scan the second test image 104. For example, the scanner device can be a network scanner device that can capture an image of the first test image 102 to generate the first scanned test image 106 utilizing the same components to capture an image of the second test image 104 to generate the second scanned image 108.

In some examples, the first scanned test image 106 can be aligned with the second scanned test image 108. For example, the plurality of color patches of the first scanned test image 106 can be aligned with the corresponding plurality of color patches of the second scanned test image 106. In some examples, the first test image 102 and the second test image 104 can include marks (e.g., fiducial marks, alignment marks, etc.) that can be utilized within the first scanned test image 106 and the second scanned test image 106 to align the corresponding color patches.

In some examples, the plurality of color patches within the first scanned test image 106 can be converted to red-green-blue (RGB) color values and/or a plurality of additional color values (e.g., lightness, saturation, hue, L*a*b*, darkness, among other color characteristics, etc.). In addition, the plurality of color patches within the second scanned test image 108 can be converted to RGB color values and/or a plurality of additional color values. In this way, the RGB color values or other color values of the first scanned test image 106 can be compared to the corresponding RGB color values or other color values of the corresponding colors within the second scanned test image 108.

As described further herein, the differences between color patches of the first scanned test image 106 and the color patches of the second scanned test image 108 can be utilized to generate an emulation color table 110. The emulation color table 110 can be a first printing device to second printing device color transformation table that can be utilized by the second printing device to generate color patches that are the same or similar to the color patches generated by the first printing device. As described further herein the emulation color table 110 can be stored as a profile for a relationship between the first printing device and the second printing device. For example, a remote printing device may be able to utilize the emulation color table 110 when the color table of the remote printing device is the same or similar model as the second printing device and the remote printing device is being altered to mimic a printing device that is the same or similar model as the first printing device.

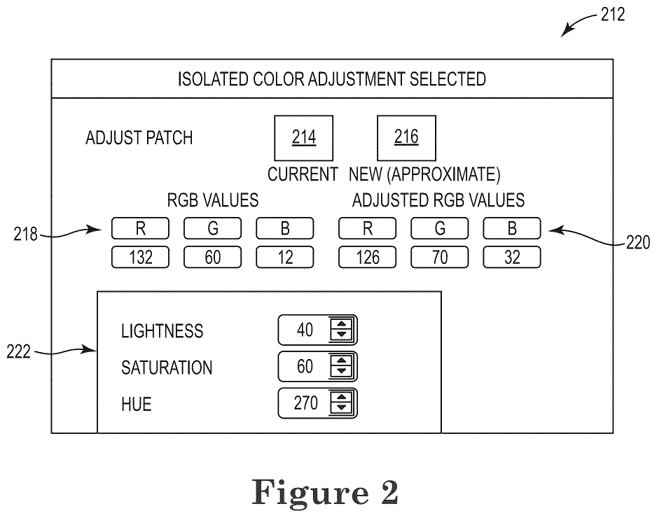

FIG. 2 illustrates an example of a user interface 212 for performing color table alterations. In some examples, the user interface 212 can be displayed on a display device. For example, a computing device embedded within a printing device or communicatively coupled to the printing device can include a display device to display images utilizing a light source. In these examples, the display device can be utilized to display visual representations of updated or altered color patches of a color table of a printing device.

In some examples, the plurality of color patches of a color table can be altered by comparing color values from a first scanned test image to corresponding color values from a second scanned test image. In these examples, each of the plurality of color patches can be altered in a similar way as described further herein with regard to altering a single color patch of the plurality of color patches. The user interface 212 can illustrate how a first color patch 214 can be altered to a second color patch 216. However, the present disclosure is not so limited, a similar alteration of the color table can be performed on a plurality of color patches of the color table.

As described herein, the first color patch 214 can be a designated color patch from a plurality of color patches of a first scanned test image. As described herein, the first scanned test image can be a scanned image of a test image that was printed by a printing device to be mimicked or to be replaced by a new printing device or updated printing device. The second color patch 216 can be a corresponding color to the first color patch from a plurality of color patches of a second scanned test image. As described herein, the corresponding color patch or second color patch 216 can be a resulting color of the second printing device when provided with the same print data as the first printing device received to print the first color patch 214.

The first color patch 214 can be analyzed to determine a first set of RGB values 218. The RGB values 218 of the first color patch 214 can include a corresponding value for red, a corresponding value for green, and/or a corresponding value for blue that is determined based on the scanned test image of the first color patch 214. The second color patch 216 could initially be printed by the second printing device utilizing the same print data, however, the resulting second color patch 216 can be analyzed to have a second set of RGB values 220. In this way, the difference between the first set of RGB values 218 and the second set of RGB values 220 can be utilized to alter the second color patch 216 within the color table to result in RGB values that are closer to the first set of RGB values 218.

In addition, the second color patch 216 can be altered with additional color features 222. For example, the additional color features 222 can include, but are not limited to: a lightness, a saturation, a Hue, among other color features. In this way, a plurality of color features of the second color patch 216 can be altered to make the second color patch 216 resemble the first color patch 214.

In some examples, the first color patch 214 can be a selected color patch from the first scanned test image of the printed test image from the first printing device. For example, the user interface 212 can display the first scanned test image and enable a selection of the first color patch 214. In these examples, the selection of the first color patch can result in displaying the user interface 212 as illustrated in FIG. 2. That is the second set of RGB values 220 can be altered to ensure that the second color patch 216 matches the first set of RGB values 218 of the first color patch 214. In these examples, the first color patch 214 can be a priority color or selected color that may be designated with a greater level of importance to ensure that the second color patch 216 is closer in color compared to other color patches of the color table for the second printing device. In this way, the priority colors or selected colors can be altered more precisely than other colors of the color table.

In some examples, a priority color can be altered to a specific set of RGB values. In these examples, the remaining colors of the color table can be altered to maintain a particular level of gradient between neighboring colors. For example, neighboring colors to the second color patch 216 can be colors that are proximate or that are contacting the second color patch 216 within the color table. In some examples, a plurality of color patches that surround or border the second color patch 216 within the color table can be shifted to ensure a particular level of gradient or color change from a particular color patch to a neighboring or proximate color patch. In this way, an updated color table will not have color changes from one color patch to a proximate color patch that exceed a color change threshold. As used herein, the color change threshold can be a color change of a set of RGB values or a single value of the RGB values (e.g., the red value, the green value, or the blue value, etc.) between a particular color patch within the color table and a proximate or neighboring color patch. The quality of the printing device can be diminished or lowered when a particular level of gradient is not maintained between the plurality of color patches of the color table. That is, colors that are intended to be closely related by RGB values or other color values with appear unrelated or have a high level of difference, which can result in low quality printed images.

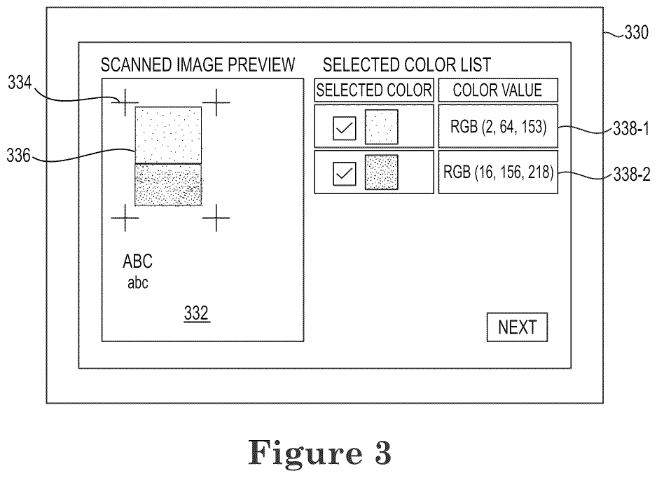

FIG. 3 illustrates an example of a user interface 330 for performing color table alterations. As described herein, the user interface 330 can be an interactive graphical user interface (GUI) or other type of user interface that allows a user to interact with a computing device or printing device. In some examples, the user interface can include a scanned test image 332 that includes an image 336. Other test images described herein utilized color gradients with a plurality of different colors that represented the color table of the particular printing device. However, the user interface 330 illustrates a scanned test image 332 that includes a particular image or logo that may be a selected region of interest.

As described herein, a region of interest can be a plurality of colors that can be relatively more important than other colors. For example, the region of interest can be a logo or trademark image for an organization. In this example, the colors associated with the logo or trademark image can be selected by the organization to ensure that a new or different printing device is able to print the logo or trademark image with particular colors that have been utilized and/or printed by other printing devices. In some examples, the user interface 330 can be utilized to select a first color 338-1 within the image 336 and/or select a second color 338-2 within the image 336. In some examples, the user interface 330 can allow for selection or deselection of the first color 338-1 and/or the second color 338-2. In some examples, a selected color can be utilized by a user interface 212 as referenced in FIG. 2 to alter the selected color to more closely represent or have similar color values (e.g., RGB values, hue values, lightness values, etc.) as a corresponding color of the image 336 generated or printed by a different printing device.

In some examples, the scanned test image 332 can include marks 334 to designate the region of interest. In some examples, the scanned test image 332 can be a scanned image of a printed test image that was generated by a printing device. In these examples, the marks 334 (e.g., fiducial marks, defining marks, border marks, etc.) can be positioned within the print data provided to a first printing device and a second printing device such that the image 336 printed by the first printing device can be aligned with a corresponding image 336 printed by the second printing device. In this way, the when the test images are scanned to generate the scanned test image 332, the image 336 can be aligned utilizing the marks 334.

In some examples, the marks 334 can designate the region of interest to perform a color histogram within an area defined by the marks 334. As used herein, a color histogram includes an image processing technique to generate a representation of the distribution of colors in the image 336 or defined area within the marks 334. For digital images, such as the scanned test image 332, a color histogram can represent the number of pixels that have colors in each of a fixed list of color ranges, that span the image's color space, the set of all possible colors. In some examples, the color of the substrate (e.g., paper, background, etc.) can be removed from the color histogram and the remaining colors can be identified as the first color 338-1 and the second color 338-1. Although two colors are identified, a plurality of additional colors can also be identified by the color histogram and provided as selectable colors.

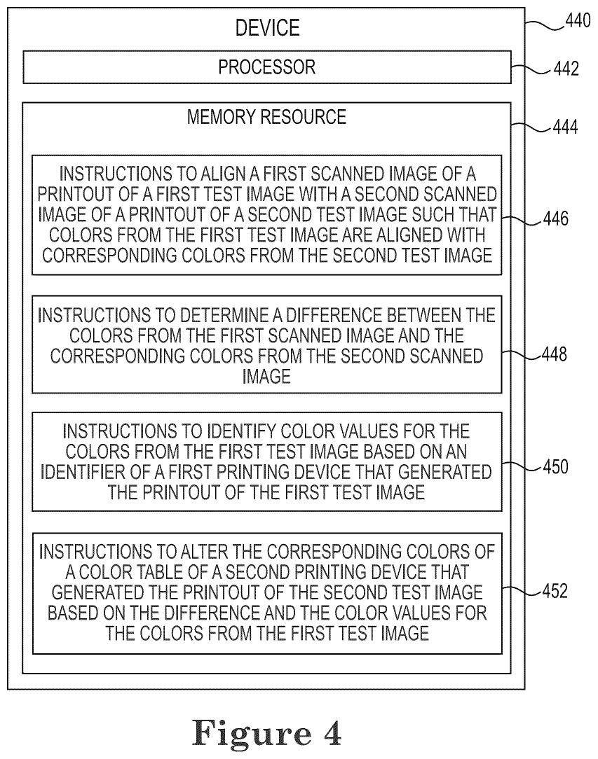

FIG. 4 illustrates an example of a device 440 for performing color table alterations. The device 440 can be a printing device and/or a computing device that can include a processor 442 that can execute instructions 446, 448, 450, 452 to perform the methods described herein. In some examples, the device 440 can include a computing device or communicatively coupled to a computing device. In other examples, the device 440 can include a controller or other hardware to executing the instructions 446, 448, 450, 452 and/or perform the methods described herein.

In some examples the device 440 can include a processor 442 (e.g., processor resource, processing resource, etc.) communicatively coupled to a memory resource 444. As described further herein, the memory resource 444 can include instructions 446, 448, 450, 452 that can be executed by the processor 442 to perform particular functions. In some examples, the device 440 is coupled to a print engine to deposit a print substance on to a substrate to generate an image on the substrate.

The device 440 can include components such as a processor 442. As used herein, the processor 442 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 446, 448, 450, 452. In other examples, the printing device 540 can include instructions 446, 448, 450, 452 stored on a machine-readable medium (e.g., memory resource 444, non-transitory computer-readable medium, etc.) and executable by a processor 442. In a specific example, the device 440 utilizes a non-transitory computer-readable medium storing instructions 446, 448, 450, 452 that, when executed, cause the processor 442 to perform corresponding functions.

As described herein, the device 440 can be a printing device that can generate images on a substrate utilizing print substances (e.g., ink, toner, etc.). The print substances can be deposited on to a substrate and have particular color properties. For example, the print substances can be deposited on to a substrate to generate an image with a plurality of colors that can each have particular properties. The plurality of colors can be generated utilizing a combination of differently colored print substances. In this way, a first printing device may generate an image with colors that have a first set of properties while a second printing device may generate the image with colors that have a second set of properties, even when the first printing device and the second printing device utilize the same digital image for the print job.

In some examples, the device 440 can be a computing device that can include instructions to send a test image to a first printing device to be generated by the first printing device and to send the test image to a second printing device to be generated by the second printing device. In this way, the device 440 can provide the same print data and/or test image to be printed by the first printing device and the second printing device. As described herein, the resulting test image generated on a corresponding substrate by the first printing device and the second printing device can be visually different when the first printing device and the second printing device are different printing devices. In other examples, the first printing device can utilize a first print color table and the second printing device can utilize a second print color table that is different than the first print color table.

In some examples, the device 440 can include instructions to instruct a scanner device to perform a first scan of the first test image on a first substrate generated by the first printing device. In addition, the device 440 can include instructions to instruct the scanner device to perform a second scan of the second test image on a second substrate generated by the second printing device. In these examples, the scanner device can be a network scanner device that can utilize the same scanning hardware to capture the scanned image of the first test image on the first substate and corresponding scanned image of the second test image on the second substrate. This can ensure scanned image consistency (e.g., color consistency, scan quality consistency, etc.) between a first scanned image of the first test image and the second scanned image of the second test image.

In some examples, the device 440 can include instructions 446 that can be executed by a processor 442 to align a first scanned image of a printout of a first test image with a second scanned image of a printout of a second test image such that colors from the first test image are aligned with corresponding colors from the second test image. As described herein, the first scanned image of the printout of the first test image can be aligned with the second test image within the second scanned image such that colors within the first test image are aligned with corresponding colors within the second test image. In this way, a first color patch within the first test image that was generated utilizing print data can be aligned with a second color patch within the second test image that was generated utilizing the same or similar print data. For example, a first set of print data can be provided to a first printing device to print the first test image and a second set of print data can be provided to a second printing device to print the second test image. In this example, the RGB values may be the same or similar for a plurality of color patches, but the location of the color patches and/or other print data associated with a corresponding printing device may be different.

In some examples, the device 440 can include instructions 448 that can be executed by a processor 442 to determine a difference between the colors from the first scanned image and the corresponding colors from the second scanned image. As described herein, the difference between the colors from the first scanned image and the corresponding colors from the second scanned image can be a difference in the color values. For example, the difference can be represented by the difference in the RGB values. In these examples, the difference of each of the RGB values can be utilized to determine how to alter or update the RGB values.

In some examples, the device 440 can include instructions 450 that can be executed by a processor 442 to identify color values for the colors from the first test image based on an identifier of a first printing device that generated the printout of the first test image. In some examples, the color values for the colors from the first test image can correspond to values associated with the color table of the first printing device or values utilized by the first printing device to generate the colors from first test image. In this way, the values utilized to generate a particular color can be utilized as input values that can correspond to the output values of the determined color values of the first test image.

In some examples, the identifier can be a code that is printed on the printout of the first test image. The identifier can be scanned by the scanner device. In some examples, the identifier can correspond to a unique identifier of the printing device. In some examples, the identifier can be utilized to identify a model, type, and/or a specific printing device. For example, the identifier can be a model number to identify a type of printing device. In another example, the identifier can be a serial number that can be utilized to identify a specific device.

In some examples, the device 440 can include instructions 452 that can be executed by a processor 442 to alter the corresponding colors of a color table of a second printing device that generated the printout of the second test image based on the difference and the color values for the colors from the first test image. As described herein, the test image printed by the first printing device and the second printing device can be the same print data that includes the same or similar color values for particular color patches. However, as described herein, the print data can also include data that is specific to a particular type of printing device, which may be different when the first printing device and second printing device are different types or models of printing devices.

In this way, the first printing device can utilize a first set of color values in response to the print data and the second printing device can utilize a second set of color values in response to the print data. In this way, the first set of values and the difference in the resulting color between the first test image and the second test image can be utilized to alter the color table of the second printing device to enable the second printing device to generate colors that are relatively closer in color values to the first printing device.

In some examples, the device 440 can include instructions to receive a selection of a single color within the first scan of the first test image. In these examples, the color value of the single color is altered for the color table of the second printing device independently of the corresponding colors. In these examples, the single color can be selected utilizing a user interface that displays the scanned first test image. In this way, a particular can be selected and isolated to be altered independently from the other colors of the color table.

As described herein, the particular color patch that was altered independently may also result in altering other color patches that are within a particular threshold area of the color table. For example, a plurality of colors that are proximate to the selected color can be altered to ensure a particular gradient between the different colors of the color table. In some examples, the quantity of proximate colors or threshold area of the color table that is altered can be based on the change to the selected color. That is, a greater change to the selected color can result in a greater threshold area or a greater quantity of proximate color patches to be altered based on the change to the selected color.

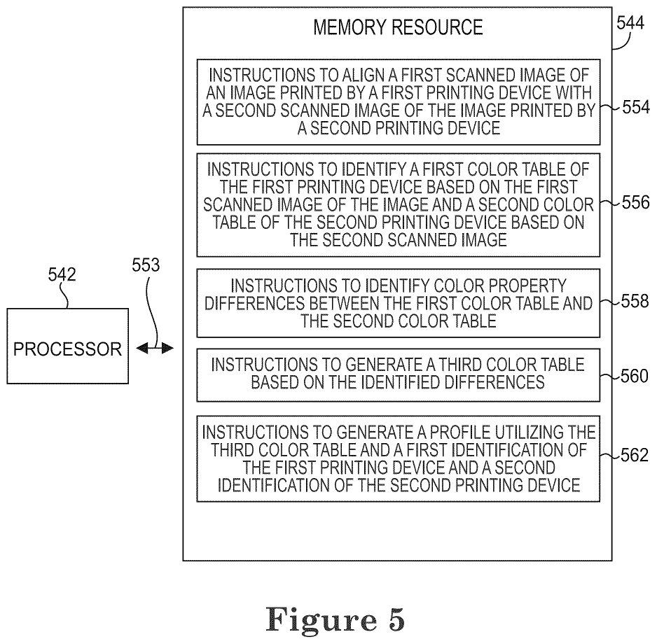

FIG. 5 illustrates an example of a memory resource 544 storing instructions 554, 556, 558, 560, 562 for performing color table alterations. In some examples, the memory resource 544 can be a part of a computing device, printing device, or controller that can be communicatively coupled to a printing system that includes printing devices or components of a printing device. For example, the memory resource 544 can be part of a device 440 as referenced in FIG. 4.

In some examples, the memory resource 544 can be communicatively coupled to a processor 542 that can execute instructions 554, 556, 558, 560, 562, stored on the memory resource 544. For example, the memory resource 544 can be communicatively coupled to the processor 542 through a communication path 553. In some examples, a communication path 553 can include a wired or wireless connection that can allow communication between devices and/or components within a single device.

The memory resource 544 may be electronic, magnetic, optical, or other physical storage device that stores executable instructions. Thus, a non-transitory machine readable medium (MRM) (e.g., a memory resource 544) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine readable medium (e.g., a memory resource 544) may be disposed within a controller and/or computing device. In this example, the executable instructions 554, 556, 558, 560, 562, can be “installed” on the device. Additionally, and/or alternatively, the non-transitory machine readable medium (e.g., a memory resource 544) can be a portable, external or remote storage medium, for example, which allows a computing system or printing system to download the instructions 554, 556, 558, 560, 562, from the portable/external/remote storage medium. In this situation, the executable instructions may be part of an “installation package”. As described herein, the non-transitory machine readable medium (e.g., a memory resource 544) can be encoded with executable instructions for performing color table alterations.

The instructions 554, when executed by the processor 542, can include instructions to align a first scanned image of an image printed by a first printing device with a second scanned image of the image printed by a second printing device. As described herein, the image printed by the first printing device and the second printing device can be printed utilizing the same print data. In this way, the image will be based on the same print data and differences between the colors of the image will correspond to differences between the printing devices. For example, the first printing device can utilize a type of print substance that is different than the second printing device. In another example, the first printing device can utilize a particular color table that is different than the second printing device. In this way, the test image printed by the first printing device may appear to have different colors than the test image printed by the second printing device.

The instructions 556, when executed by the processor 542, can include instructions to identify a first color table of the first printing device based on the first scanned image of the image and a second color table of the second printing device based on the second scanned image. As described herein, the first color table corresponding to the first printing device can include an identified color value of a plurality of colors within the test image. In a similar way, the second color table of the second printing device be identified color values for the plurality of colors within the test image generated by the second printing device. In this way, the actual color values of the printed test image from the first printing device and the second printing device can be utilized as corresponding color tables for the first printing device and the second printing device. In some examples, the first color table can include color properties (e.g., RGB values, etc.) for each of a plurality of color patches of the test image based on the first scanned image and the second color table can include color properties for each of a plurality of color patches of the test image based on the second scanned image.

The instructions 558, when executed by the processor 542, can include instructions to identify color property differences between the first color table and the second color table. As described herein, each of a plurality of color patches within the first scanned image can be compared to a corresponding plurality of color patches within the second scanned image to determine the color property differences. For example, the difference between the RGB values within the plurality of color patches within the first color table and the RGB values within the plurality of corresponding color patches within the second color table can be identified or calculated.

The instructions 560, when executed by the processor 542, can include instructions to generate a third color table based on the identified differences. As described herein, the third color table can be an emulation color table that can be utilized by the second printing device to generate images on a substrate that have resulting color properties that are the same or similar to the first printing device. In some examples, the third color table or emulation color table can be a conversion color table that can be utilized to alter values associated with the second color table to alter the color values generated by the second printing device to be the same or closer to the color values generated by the first printing device.

The instructions 562, when executed by the processor 542, can include instructions to generate a profile utilizing the third color table and a first identification of the first printing device and a second identification of the second printing device. In some examples, the profile can be generated to be utilized by the second printing device when the second printing device is to mimic the first printing device. For example, the second printing device can include a user interface that can be utilized to select an identification of the first printing device. Upon selection of the first printing device, the second printing device can utilize the profile that includes the third color table or emulation color table for the first printing device.

In some examples, the memory resource 544 can include instructions to receive the identification of the first printing device from a third printing device, determine the third printing device includes the second identification of the second printing device, and provide the profile to the third printing device to alter an existing color table of the third printing device with the third color table. In this example, the second printing device can be a particular type or model of printing device. In these examples, the third printing device can be the same type or model of printing device as the second printing device. In some examples, the third printing device may want to mimic or print images that are the same or similar as the first printing device. In these examples, the profile can be provided to the third printing device to utilize the third color table or emulation table.

In some examples, the memory resource 544 can include instructions to display the first scanned image on a display device and receive a selection of a region of interest from the first scanned image. In these examples, a color patch of the first color table is a selected based on the selected region of interest that includes a plurality of colors with corresponding color patches. As described herein, the memory resource 544 can include instructions to generate a color histogram for the region of interest to identify a color within the region of interest that corresponds to the color patch. In these examples, the region of interest can be selected to identify a priority level of a particular color a plurality of colors. As described herein, the selected colors with a relatively high priority level can be altered independently from the rest of the third color table. In addition, proximate color patches to the selected colors can be altered based on the alteration to the selected color patches.

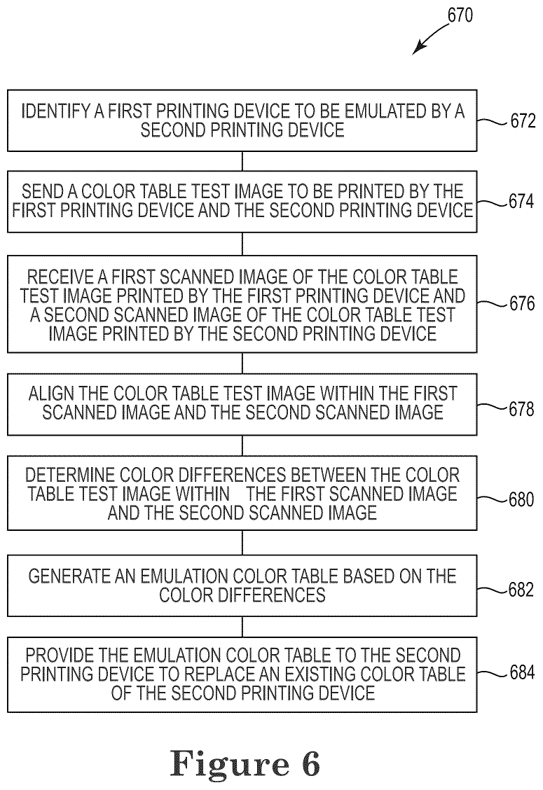

FIG. 6 illustrates an example of a method 670 for performing color table alterations. In some examples, the method 670 can be performed by a computing device, a printing device, and/or a controller. That is, the method 670 can illustrate instructions that can be stored on a non-transitory computer readable medium and executed by a process to perform the functions of the method 670. In some examples, a portion of the method 670 can be performed by a computing device coupled to a printing device where a portion of the method 670 is performed by the computing device and another portion is performed by the printing device.

At 672, the method 670 can identify a first printing device to be emulated by a second printing device. As described herein, identifying the first printing device to be emulated or mimicked by the second printing device can be performed by receiving a selection of an identification of the first printing device at the second printing device or computing device associated with the second printing device. For example, an address of the first printing device can be provided to a user interface. The address can be an IP address or email address associated with the first printing device. In some examples, an identification or address of the second printing device can also be provided to the user interface.

At 674, the method 670 can send a color table test image to be printed by the first printing device and the second printing device. In some examples, the color table test image can be print data to be printed by a printing device. In some examples, the color table test image print data can be sent to the first printing device based on the address provided to the user interface and sent to the second printing device based on the address provided to the user interface. As described herein, the color table test image print data can be the same print data provided to both the first printing device and the second printing device.

At 676, the method 670 can receive a first scanned image of the color table test image printed by the first printing device and a second scanned image of the color table test image printed by the second printing device. In these examples, the first scanned image and the second scanned image are generated by a single scanner device. In some examples, the first scanned image and the second scanned image can be received at a computing device connected to a network and/or communicatively coupled to the first printing device and the second printing device.

At 678, the method 670 can align the color table test image within the first scanned image and the second scanned image. As described herein, the color table test image can include a plurality of colors aligned by a gradient similar to a color table of the first printing device and/or the second printing device. In some examples, the color table test image includes a plurality of color patches that are deposited based on the color table of the first printing device or second printing device. In this way, the plurality of color patches from the first scanned image can be aligned to be compared with the corresponding plurality of color patches from the second scanned image. In some examples, marks can be utilized to align the color table test image within the first scanned image to the color table test image within the second scanned image.

At 680, the method 670 can determine color differences between the color table test image withing the first scanned image and the second scanned image. As described herein, the color differences can correspond to a color value difference between the color table test image within the first scanned image and the color table test image within the second scanned image. In some examples, the color differences can be differences in RGB values between the color table test image within the first scanned image and the color table test image within the second scanned image.

At 682, the method 670 can generate an emulation color table based on the color differences. In these examples, the emulation color table includes a color value to be utilized by a particular printing device when generating an image on a substrate. As described herein, the emulation color table can be a conversion table that can be utilized by the second computing device to generate colors that have RGB values that are closer to the RGB values within the color table test image within the first scanned image.

At 684, the method 670 can provide the emulation color table to the second printing device to replace an existing color table of the second printing device. As described herein, the emulation color table can be a complete color table that can be utilized to replace the existing color table utilized by the second printing device to generate the color table test image. In other examples, the emulation color table can be a conversion table that can be utilized with the existing color table utilized by the second printing device.

In some examples, the method 670 includes identifying a single color patch of the emulation color table, altering color values of the single color patch based on a selected color patch within the first scanned image and altering neighboring color patches of the single color patch within the emulation color table based on the altered color values of the single color patch. As described herein, neighboring color patches can include color patches that are proximate to the selected color patch within the color table. In other examples, the neighboring color patches can be color patches that are within a particular quantity of color patches to the selected color patch. In this way, a gradient or gradient level can be maintained when the selected color is altered to different color values.

In some examples, the method 670 includes generating a color histogram for a region of interest based on fiducial marks within the first scanned image and the second scanned image. As described herein, a color histogram can analyze the region of interest to identify the different colors within the region of interest. In this way, each of a plurality of identified colors within the region of interest can be individually altered to have more precise color values that corresponds to the color values printed by the first printing device. In a similar way, the neighboring color patches to the identified colors within the region of interest can be altered based on how the identified colors are altered. As described herein, altering the neighboring colors to the identified colors can maintain a particular gradient within a region of the identified colors.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A device, comprising:
a processor; and
a non-transitory memory resource storing machine-readable instructions stored thereon that, when executed, cause the processor to:
align a first scanned image of a printout of a first test image with a second scanned image of a printout of a second test image such that colors from the first test image are aligned with corresponding colors from the second test image;
determine a difference between the colors from the first scanned image and the corresponding colors from the second scanned image;
identify color values for the colors from the first test image based on an identifier of a first printing device that generated the printout of the first test image; and
alter the corresponding colors of a color table of a second printing device that generated the printout of the second test image based on the difference and the color values for the colors from the first test image.

2. The device of claim 1, wherein the processor is to:
instruct a scanner device to perform a scan to generate the first scanned image from the printout of the first test image; and
instruct the scanner device to perform a scan to generate the second scanned image from the printout of the first test image.

3. The device of claim 1, wherein the processor is to receive a selection of a single color within the first scanned image of the first test image or the second scanned image of the second test image, wherein the color value of the single color is altered for the color table of the second printing device independently of the corresponding colors.

4. The device of claim 1, wherein the first test image is the same as the second test image.

5. The device of claim 1, wherein the processor is to send the first test image to the first printing device to be printed by the first printing device and to send the second test image to the second printing device to be printed by the second printing device.

6. A non-transitory memory resource storing machine-readable instructions stored thereon that, when executed, cause a processor to:
align a first scanned image of an image printed by a first printing device with a second scanned image of the image printed by a second printing device;
identify a first color table of the first printing device based on the first scanned image of the image and a second color table of the second printing device based on the second scanned image;
identify color property differences between the first color table and the second color table;
generate a third color table based on the identified differences; and
generate a profile utilizing the third color table and a first identification of the first printing device and a second identification of the second printing device.

7. The memory resource of claim 6, wherein the non-transitory memory resource include instructions that cause the processor to:
receive the identification of the first printing device from a third printing device;
determine the third printing device includes the second identification of the second printing device; and
provide the profile to the third printing device to alter an existing color table of the third printing device with the third color table.

8. The memory resource of claim 6, wherein the non-transitory memory resource include instructions that cause the processor to:
display the first scanned image on a display device; and
receive a selection of a region of interest from the first scanned image.

9. The memory resource of claim 8, wherein a color patch of the first color table is a selected based on the selected region of interest that includes a plurality of colors with corresponding color patches.

10. The memory resource of claim 9, wherein the non-transitory memory resource include instructions that cause the processor to generate a color histogram for the region of interest to identify a color within the region of interest that corresponds to the color patch.

11. A method, comprising:
identifying a first printing device to be emulated by a second printing device;
sending a color table test image to be printed by the first printing device and the second printing device;
receiving a first scanned image of the color table test image printed by the first printing device and a second scanned image of the color table test image printed by the second printing device;
aligning the color table test image within the first scanned image and the second scanned image;
determining color differences between the color table test image within the first scanned image and the second scanned image;
generating an emulation color table based on the color differences; and
providing the emulation color table to the second printing device to replace an existing color table of the second printing device.

12. The method of claim 11, wherein the emulation color table includes a color value to be utilized by a particular printing device when printing an image on a substrate.

13. The method of claim 11, wherein the first scanned image and the second scanned image are generated by a single scanner device.

14. The method of claim 11, further comprising:
identifying a single color patch of the emulation color table;
altering color values of the single color patch based on a selected color patch within the first scanned image; and
altering neighboring color patches of the single color patch within the emulation color table based on the altered color values of the single color patch.

15. The method of claim 11, further comprising generating a color histogram for a region of interest based on fiducial marks within the first scanned image and the second scanned image.
